(19) United States
(12) Patent Application Publication
(10) Pub. No.: US 2025/0084008 A1
(43) Pub. Date: Mar. 13, 2025

(54) CONTAINER MADE OF A COATED CERAMIC MATRIX COMPOSITE

(71) Applicant: SAINT-GOBAIN CENTRE DE RECHERCHES ET D'ETUDES EUROPEEN, COURBEVOIE (FR)

(72) Inventors: Franceline Marguerite Louise VILLERMAUX, CAVAILLON CEDEX (FR); Costana Mihaela IONICA BOUSQUET, CAVAILLON CEDEX (FR); Emmanuel NONNET, CAVAILLON CEDEX (FR)

(21) Appl. No.: 18/721,576

(22) PCT Filed: Dec. 23, 2022
(86) PCT No.: PCT/FR2022/052493

§ 371 Date: Jun. 18, 2024

(30) Foreign Application Priority Data
Dec. 23, 2021 (FR) FR2114401

(51) Int. Cl. C04B 41/50; B65D 25/14; C04B 35/80; C04B 41/87

(52) U.S. Cl. CPC C04B 41/5024; B65D 25/14; C04B 35/80; C04B 41/87

(57) ABSTRACT

A container made of a ceramic matrix composite, wherein the surface of the interior walls of the container are covered at least partially with a coating including at least one layer including a crystalline oxide including at least the elements Li and Al or a precursor of the crystalline oxide.

### TECHNICAL FIELD

The present invention relates to a container made of a ceramic matrix composite, or CMC, wherein the surface of the inner walls is at least partially covered, preferably more than 80%, by a coating comprising at least one layer comprising a crystalline oxide comprising at least the elements Li and Al, and to the use of said container for the manufacture of an oxide powder comprising lithium, in particular an oxide of a metal or of several lithiated transition metals.

### PRIOR ART

The need for lithium-ion batteries is constantly increasing. A good number of them comprise a part, generally the cathode, made of an oxide comprising lithium, in particular an oxide of a metal or of several lithiated transition metals, in particular LiFePO₄ (or LPF), LiMn₂O₄ (or LMO), or a lithium-nickel-cobalt-manganese (or Li-NMC) oxide.

The cathode is generally manufactured by shaping a powder of said oxide of a metal or several lithiated transition metals.

Among the conventional methods for manufacturing said powders, the production of a mixture of oxides and/or of different oxide precursors, followed by a heat treatment that makes it possible to carry out a solid-phase synthesis of the oxide of a metal or of several lithiated transition metals. During said heat treatment, the mixture is placed in container, generally called a saggar. The conditions for synthesizing said powders, as well as said mixture, in particular the elements containing lithium, are particularly demanding for the container.

There is a need to increase the lifespan of said containers.

One aim of the invention is to at least partially meet this need.

### OVERVIEW OF THE INVENTION

According to the invention, this aim is achieved by means of a container made of a ceramic matrix composite, or CMC, wherein the surface of the interior walls of said container is covered at least partially, preferably more than 80%, and more preferably over the entirety of said interior walls, by a coating comprising at least one layer comprising a crystalline oxide comprising at least the elements Li and Al, or a precursor of said crystalline oxide.

The inventors have discovered that the container according to the invention had lower degradation during its use, which allows a longer lifetime, and in particular a greater number of cycles for manufacturing oxide powder of a metal or multiple lithiated transition metals.

According to preferred but non-limiting embodiments of the present invention, which may, if appropriate, be combined with one another:
said crystalline oxide also comprises the element Si;
said crystalline oxide is chosen from LiAlO₂, LiAlSi₂O₆, Li₃AlSiO₅, LiAlSi₄O₁₀, LiAlSiO₄ and mixtures thereof; in particular LiAlSi₂O₆, Li₃AlSiO₅, LiAlSi₄O₁₀, LiAlSiO₄ and mixtures thereof;
the ceramic fibers of the ceramic matrix composite, optionally assembled in the form of single and/or assembled bundles, are selected from fibers comprising more than 95% by mass, and preferably consist essentially of oxides, carbides, nitrides, carbon and mixtures thereof;
the ceramic fibers of the ceramic matrix composite, optionally assembled in the form of single and/or assembled bundles, are selected from the fibers:
comprising more than 95% by mass of oxides, preferably consisting essentially of oxides, and having a chemical analysis such that SiO₂>70%, as a mass percentage relative to all oxides,
comprising more than 95% by mass of oxides, preferably consisting essentially of oxides, and exhibiting a chemical analysis such that 45%<SiO₂<80%, and iron oxide, expressed in the form Fe₂O₃ in an amount such that 1%<Fe₂O₃<20% and 5%<Al₂O₃<25%, as a mass percentage relative to all oxides,
comprising more than 95% by mass of oxides, preferably consisting essentially of oxides, and having a chemical analysis such that Al₂O₃>65%, as a mass percentage relative to all oxides,
comprising more than 95% by mass of silicon carbide, preferably consisting essentially of silicon carbide,
comprising more than 95% by mass of carbon, preferably consisting essentially of carbon,
and mixtures thereof;
the ceramic fibers of the ceramic matrix composite, optionally assembled in the form of single and/or assembled bundles, are selected from the fibers more than 95% composed of alumina by mass, the fibers more than 95% composed of silica by mass, the fibers more than 95% composed of mullite by mass, the fibers more than 95% composed of mullite and corundum by mass, the fibers more than 90% composed of basalt by mass, the fibers more than 95% composed of glass by mass, the fibers more than 95% composed of silicon carbide by mass, the fibers more than 95% composed of carbon by mass, and mixtures thereof;
the matrix of the ceramic matrix composite is chosen from a matrix comprising more than 95% by mass of oxides, carbides, nitrides, sialons and mixtures thereof, and in particular a matrix consisting essentially of oxides, carbides, nitrides, sialons and mixtures thereof;
the matrix of the ceramic matrix composite is selected from a matrix
comprising more than 95% by mass of oxides and having a chemical analysis such that SiO₂+Al₂O₃+ZrO₂+HfO₂+MgO>70% by mass percentage relative to all oxides,
comprising more than 95% by mass of oxides and having a chemical analysis such that SiO₂+Al₂O₃>70% by mass percentage relative to all oxides,
comprising more than 95% by mass of oxides and having a chemical analysis such that Al₂O₃+ZrO₂+HfO₂>70% by mass percentage relative to all oxides,
comprising more than 95% by mass of oxides and having a chemical analysis such that SiO₂+Al₂O₃+MgO>70% by mass percentage relative to all oxides,
comprising more than 90% by mass of SiC+Si₃N₄+SiAlON;
the coating comprises at least one layer comprising a crystalline oxide comprising at least the elements Li, Al and Si;
the coating consists of more than 15% by mass of one or more crystalline oxides comprising at least the elements Li and Al;
the coating contains a precursor of at least one crystalline oxide comprising at least the elements Li and Al, preferably chosen from lithiated bayerite, Li₄SiO₄ and mixtures thereof;
the coating has the following chemical composition, by mass percentage relative to all oxides:
SiO₂+Al₂O₃+Li₂O>50%, and
Li₂O: >0.5% and <30%, and/or
Al₂O₃: >2% and <80%, and/or
SiO₂: <5%, or 10%<SiO₂<80%;
the coating consists of more than 90% by mass of oxides;
the coating has a thickness greater than 50 μm and/or less than 2000 μm;
more than 99% of the surface of the interior walls is covered by said coating;
the container comprises a bottom and at least one side.

The invention also relates to the use of said container for the manufacture of an oxide powder comprising lithium, in particular an oxide of a metal or multiple lithiated transition metals.

### Definitions

“Ceramic Matrix Composite” or “CMC” is conventionally understood to mean a product composed of ceramic fibers rigidly linked together by a ceramic matrix.
“Ceramic” is understood to mean a product which is neither metallic nor organic. In the context of the present invention, an oxide glass and a material comprising or consisting of carbon are considered to be ceramic products.
“Coating” is understood to mean one or more layers of material(s) of different nature from the CMC substrate. At least one of said layers, in particular the layer comprising a crystalline oxide comprising at least the elements Li and Al, may be the result, in particular after raising the temperature, of the reaction of the CMC support and of a deposition on the surface of said CMC.
“Precursor” of a crystalline oxide is understood to mean one or more materials, which will lead after heat treatment, preferably in air, at a temperature above 400° C., in particular during the first use of the container according to the invention, optionally in combination with one or more elements of the CMC, to said crystalline oxide.
A “fiber” is a filament whose length is greater than 5 times its equivalent diameter.
The “equivalent diameter” of a fiber is the diameter of a disc of the same surface as its cross-section at half-length.
A “simple bundle” is an assembly of fibers that, in cross-section, comprises more than 10 and preferably fewer than 500,000 fibers, and whose length is greater than 5 times the diameter.
An “assembled bundle” is an assembly of bundles.
A“sialon”, SiAlON, is a compound of oxynitride of at least the elements Si, Al and N, in particular a compound complying with one of the following formulas:
SiₓAl_{y}OᵤNᵥ, wherein:
x is greater than or equal to 0, greater than 0.05, greater than 0.1 or greater than 0.2, and less than or equal to 1, less than or equal to 0.8 or less than or equal to 0.4,
y is greater than or equal to 0, or greater than 0.1, greater than 0.3 or greater than 0.5, and less than or equal to 1,
u is greater than 0, greater than 0.1 or greater than 0.2, and less than or equal to 1 or less than or equal to 0.7,
v is greater than 0, greater than 0.1, greater than 0.2 or greater than 0.5, or greater than 0.7, and less than or equal to 1,
x+y>0,
x, y, u and v being stoichiometric indices, normalized relative to that which is the highest, which is made equal to 1;
MeₓSi₁₂₋₍ₘ₊ₙ₎Al₍ₘ₊ₙ₎OₙN₁₆₋ₙ, where 0≤x≤2, Me is a cation selected from lanthanides, Fe, Y, Ca, Li cations and mixtures thereof, 0≤m≤12, 0≤n≤12 and 0<n+m≤12, generally called “α-SiAlON” or “SiAlON-α′”
For the sake of clarity, the chemical formulae of the simple oxides are used to designate the content levels of these oxides in a composition. For example, “SiO₂” or “Al₂O₃” refers to the contents of these simple oxides in the chosen composition, while “silica” and “alumina” are used to denote the actual presence of phases of these oxides consisting of SiO₂ and Al₂O₃, respectively.
Unless otherwise mentioned, all the contents of oxides are mass percentages on the basis of the oxides. A mass content of an oxide of a metal element relates to the total content of this element expressed in the form of the most stable oxide, according to the usual convention of the industry.
HfO₂ is not chemically dissociable from ZrO₂. However, according to the present invention, HfO₂ is not intentionally added. HfO₂ therefore only refers to the inevitable impurities of hafnium oxide, this oxide always being naturally present in zirconia sources at mass contents generally less than 5%, generally less than 2%. For the sake of clarity, the total content of zirconium oxide and of traces of hafnium oxide can be denoted interchangeably as “ZrO₂” or as “ZrO₂+HfO₂”.
The sum of contents of oxides does not imply the presence of all these oxides.
“comprise” should be interpreted non-limitingly, in the sense that elements other than those indicated may be present.

### DETAILED DESCRIPTION

### CMC

A CMC is conventionally a product composed of ceramic fibers rigidly linked together by a ceramic matrix.

Preferably, the ceramic fibers, optionally assembled in the form of single and/or assembled bundles, are chosen from fibers comprising more than 95%, preferably more than 97%, preferably more than 98%, preferably more than 99%, preferably more than 99.5% by mass of oxides, carbides, nitrides, carbon and mixtures thereof.

Preferably, the ceramic fibers, optionally assembled in the form of single and/or assembled bundles, are selected from the fibers:
comprising more than 95%, preferably more than 97%, preferably more than 98%, preferably more than 99%, preferably more than 99.5% by mass of oxides and having a chemical analysis such that SiO₂>70%, preferably SiO₂>80%, preferably SiO₂>90%, or even SiO₂>99%, by mass percentage relative to all oxides,
comprising more than 95%, preferably more than 97%, preferably more than 98%, preferably more than 99%, preferably more than 99.5% by mass of oxides and having a chemical analysis such that SiO₂>45%, preferably SiO₂>50% and SiO₂<80%, and iron oxide, expressed in the form Fe₂O₃ in an amount such that 1%<Fe₂O₃<20% and 5%<Al₂O₃<25%, by mass percentage relative to all oxides,
comprising more than 95%, preferably more than 97%, preferably more than 98%, preferably more than 99%, preferably more than 99.5% by mass of oxides and having a chemical analysis such that Al₂O₃>65%, preferably Al₂O₃>70%, or even Al₂O₃>80%, or even Al₂O₃>90%, or even Al₂O₃>95%, by mass percentage relative to all oxides,
comprising more than 95%, preferably more than 97%, preferably more than 98%, preferably more than 99%, preferably more than 99.5% by mass of silicon carbide,
comprising more than 95%, preferably more than 97%, preferably more than 98%, preferably more than 99%, preferably more than 99.5% by mass of carbon,
and mixtures thereof.

In one embodiment, the ceramic fibers, optionally assembled in the form of single and/or assembled bundles, are selected from fibers more than 95%, preferably more than 98%, preferably more than 99%, preferably substantially 100% composed of alumina by mass, fibers more than 95%, preferably more than 98%, preferably more than 99%, preferably substantially 100% composed of silica by mass, preferably more than 95%, preferably more than 98%, preferably more than 99%, preferably substantially 100% composed of amorphous silica by mass, the fibers more than 95%, preferably more than 98%, preferably more than 99%, preferably substantially 100% composed of mullite by mass, the fibers more than 95%, preferably more than 98%, preferably more than 99%, preferably substantially 100% composed of mullite and corundum by mass, the fibers more than 90%, preferably more than 95%, preferably more than 98%, preferably more than 99%, preferably substantially 100% composed of basalt by mass, the fibers more than 95%, preferably more than 98%, preferably more than 99%, preferably substantially 100%, composed of glass by mass, preferably washed, fibers more than 95%, preferably more than 98%, preferably more than 99%, preferably substantially 100% composed of silicon carbide by mass, fibers more than 95%, preferably more than 98%, preferably more than 99%, preferably substantially 100% of composed carbon and mixtures thereof of by mass.

Preferably, the CMC matrix is chosen from a matrix comprising more than 95%, preferably more than 97%, preferably more than 98%, preferably more than 99%, preferably more than 99.5% by mass of oxides, carbides, nitrides, sialons and mixtures thereof.

Preferably, the CMC matrix is selected from a matrix:
comprising more than 95%, preferably more than 97%, preferably more than 98%, preferably more than 99%, preferably more than 99.5% by mass of oxides and having a chemical analysis such that SiO₂+Al₂O₃+ZrO₂+HfO₂+MgO>70%, preferably SiO₂+Al₂O₃+ZrO₂+HfO₂+MgO>80%, preferably SiO₂+Al₂O₃+ZrO₂+HfO₂+MgO>90%, preferably SiO₂+Al₂O₃+ZrO₂+HfO₂+MgO>95%, preferably SiO₂+Al₂O₃+ZrO₂+HfO₂+MgO>98%, or even SiO₂+Al₂O₃+ZrO₂+HfO₂+MgO>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃>70%, preferably SiO₂+Al₂O₃>80%, preferably SiO₂+Al₂O₃>90%, preferably SiO₂+Al₂O₃>95%, preferably SiO₂+Al₂O₃>98%, or even SiO₂+Al₂O₃>99%, by mass percentage relative to all oxides,
comprising more than 95%, preferably more than 97%, preferably more than 98%, preferably more than 99%, preferably more than 99.5% by mass of oxides and having a chemical analysis such that Al₂O₃+ZrO₂+HfO₂>70%, preferably Al₂O₃+ZrO₂+HfO₂>80%, preferably Al₂O₃+ZrO₂+HfO_{2>90}%, preferably Al₂O₃+ZrO₂+HfO_{2>95}%, preferably Al₂O₃+ZrO₂+HfO₂>98%, or even Al₂O₃+ZrO₂+HfO₂>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃+MgO>70%, preferably SiO₂+Al₂O₃+MgO>80%, preferably SiO₂+Al₂O₃+MgO>90%, preferably SiO₂+Al₂O₃+MgO>95%, preferably SiO₂+Al₂O₃+MgO>98%, or even SiO₂+Al₂O₃+MgO>99%, by mass percentage relative to all oxides,
comprising more than 90%, preferably more than 95%, preferably more than 97%, preferably more than 98%, preferably more than 99% by mass of SiC+Si₃N₄+SiAlON. In one embodiment, in particular when the matrix comprises more than 50%, preferably more than 60%, preferably more than 70%, preferably more than 80% by mass of SiC, the complement to SiC+Si₃N₄+SiAlON in said matrix comprises metallic silicon, preferably said complement consists of more than 70%, preferably for more than 80%, preferably for more than 90% by mass, of metallic silicon.

In one embodiment, the CMC is such that the fibers of said CMC, optionally assembled in the form of single and/or assembled bundles, comprise more than 95%, preferably more than 97%, preferably more than 98%, preferably more than 99%, preferably more than 99.5% by mass of oxides and have a chemical analysis such that SiO₂>70%, preferably SiO₂>80%, preferably SiO₂>90%, or even SiO₂>99%, by mass percentage relative to all oxides, and the matrix of said CMC is selected from a matrix:
comprising more than 95%, preferably more than 97%, preferably more than 98%, preferably more than 99%, preferably more than 99.5% by mass of oxides and having a chemical analysis such that SiO₂+Al₂O₃+ZrO₂+HfO₂+MgO>70%, preferably SiO₂+Al₂O₃+ZrO₂+HfO₂+MgO>80%, preferably SiO₂+Al₂O₃+ZrO₂+HfO₂+MgO>90%, preferably SiO₂+Al₂O₃+ZrO₂+HfO₂+MgO>95%, preferably SiO₂+Al₂O₃+ZrO₂+HfO₂+MgO>98%, or even SiO₂+Al₂O₃+ZrO₂+HfO₂+MgO>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃>70%, preferably SiO₂+Al₂O₃>80%, preferably SiO₂+Al₂O₃>90%, preferably SiO₂+Al₂O₃>95%, preferably SiO₂+Al₂O₃>98%, or even SiO₂+Al₂O₃>99%, by mass percentage relative to all oxides,
comprising more than 95%, preferably more than 97%, preferably more than 98%, preferably more than 99%, preferably more than 99.5% by mass of oxides and having a chemical analysis such that Al₂O₃+ZrO₂+HfO₂>70%, preferably Al₂O₃+ZrO₂+HfO₂>80%, preferably Al₂O₃+ZrO₂+HfO₂>90%, preferably Al₂O₃+ZrO₂+HfO₂>95%, preferably Al₂O₃+ZrO₂+HfO₂>98%, or even Al₂O₃+ZrO₂+HfO₂>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃+MgO>70%, preferably SiO₂+Al₂O₃+MgO>80%, preferably SiO₂+Al₂O₃+MgO>90%, preferably SiO₂+Al₂O₃+MgO>95%, preferably SiO₂+Al₂O₃+MgO>98%, or even SiO₂+Al₂O₃+MgO>99%, by mass percentage relative to all oxides.

In one embodiment, the CMC is such that the fibers of said CMC, optionally assembled in the form of single and/or assembled bundles, comprise more than 95%, preferably more than 97%, preferably more than 98%, preferably more than 99%, preferably more than 99.5% by mass of oxides and have a chemical analysis such that SiO₂>45%, preferably SiO₂>50% and SiO_{2<80}%, and iron oxide, expressed in the form Fe₂O₃ in an amount such that 1%<Fe₂O₃<20% and 5%<Al₂O₃<25%, by mass percentage relative to all oxides, and the matrix of said CMC is chosen from a matrix:
comprising more than 95%, preferably more than 97%, preferably more than 98%, preferably more than 99%, preferably more than 99.5% by mass of oxides and having a chemical analysis such that SiO₂+Al₂O₃+ZrO₂+HfO₂+MgO>70%, preferably SiO₂+Al₂O₃+ZrO₂+HfO₂+MgO>80%, preferably SiO₂+Al₂O₃+ZrO₂+HfO₂+MgO>90%, preferably SiO₂+Al₂O₃+ZrO₂+HfO₂+MgO>95%, preferably SiO₂+Al₂O₃+ZrO₂+HfO₂+MgO>98%, or even SiO₂+Al₂O₃+ZrO₂+HfO₂+MgO>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃>70%, preferably SiO₂+Al₂O₃>80%, preferably SiO₂+Al₂O₃>90%, preferably SiO₂+Al₂O₃>95%, preferably SiO₂+Al₂O₃>98%, or even SiO₂+Al₂O₃>99%, by mass percentage relative to all oxides,
comprising more than 95%, preferably more than 97%, preferably more than 98%, preferably more than 99%, preferably more than 99.5% by mass of oxides and having a chemical analysis such that Al₂O₃+ZrO₂+HfO₂>70%, preferably Al₂O₃+ZrO₂+HfO₂>80%, preferably Al₂O₃+ZrO₂+HfO₂>90%, preferably Al₂O₃+ZrO₂+HfO₂>95%, preferably Al₂O₃+ZrO₂+HfO₂>98%, or even Al₂O₃+ZrO₂+HfO₂>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃+MgO>70%, preferably SiO₂+Al₂O₃+MgO>80%, preferably SiO₂+Al₂O₃+MgO>90%, preferably SiO₂+Al₂O₃+MgO>95%, preferably SiO₂+Al₂O₃+MgO>98%, or even SiO₂+Al₂O₃+MgO>99%, by mass percentage relative to all oxides.

In one embodiment, the CMC is such that the fibers of said CMC, optionally assembled in the form of single and/or assembled bundles, comprise more than 95%, preferably more than 97%, preferably more than 98%, preferably more than 99%, preferably more than 99.5% by mass of oxides and have a chemical analysis such that Al₂O₃>65%, preferably Al₂O₃>70%, or even Al₂O₃>80%, or even Al₂O₃>90%, or even Al₂O₃>95%, by mass percentage relative to all oxides, and the matrix of said CMC is chosen from a matrix:
comprising more than 95%, preferably more than 97%, preferably more than 98%, preferably more than 99%, preferably more than 99.5% by mass of oxides and having a chemical analysis such that SiO₂+Al₂O₃+ZrO₂+HfO₂+MgO>70%, preferably SiO₂+Al₂O₃+ZrO₂+HfO₂+MgO>80%, preferably SiO₂+Al₂O₃+ZrO₂+HfO₂+MgO>90%, preferably SiO₂+Al₂O₃+ZrO₂+HfO₂+MgO>95%, preferably SiO₂+Al₂O₃+ZrO₂+HfO₂+MgO>98%, or even SiO₂+Al₂O₃+ZrO₂+HfO₂+MgO>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃>70%, preferably SiO₂+Al₂O₃>80%, preferably SiO₂+Al₂O₃>90%, preferably SiO₂+Al₂O₃>95%, preferably SiO₂+Al₂O₃>98%, or even SiO₂+Al₂O₃>99%, by mass percentage relative to all oxides,
comprising more than 95%, preferably more than 97%, preferably more than 98%, preferably more than 99%, preferably more than 99.5% by mass of oxides and having a chemical analysis such that Al₂O₃+ZrO₂+HfO₂>70%, preferably Al₂O₃+ZrO₂+HfO₂>80%, preferably Al₂O₃+ZrO₂+HfO₂>90%, preferably Al₂O₃+ZrO₂+HfO₂>95%, preferably Al₂O₃+ZrO₂+HfO₂>98%, or even Al₂O₃+ZrO₂+HfO₂>99%, by mass percentage relative to all oxides,
comprising more than 95%, preferably more than 97%, preferably more than 98%, preferably more than 99%, preferably more than 99.5% by mass of oxides and having a chemical analysis such that SiO₂+Al₂O₃+MgO>70%, preferably SiO₂+Al₂O₃+MgO>80%, preferably SiO₂+Al₂O₃+MgO>90%, preferably SiO₂+Al₂O₃+MgO>95%, preferably SiO₂+Al₂O₃+MgO>98%, or even SiO₂+Al₂O₃+MgO>99%, by mass percentage relative to all oxides,
comprising more than 85%, preferably more than 90%, preferably more than 95%, preferably more than 97%, preferably more than 98%, preferably more than 99% by mass of SiC+Si₃N₄+SiAlON. In one embodiment, in particular when the matrix comprises more than 50%, preferably more than 60%, preferably more than 70%, preferably more than 80% by mass of SiC, the complement to SiC+Si₃N₄+SiAlON comprises metallic silicon, preferably said complement consists of more than 70%, preferably for more than 80%, preferably for more than 90% by mass, of metallic silicon.

In one embodiment, the CMC is such that the fibers of said CMC, optionally assembled in the form of single and/or assembled bundles, comprise more than 95%, preferably more than 97%, preferably more than 98%, preferably more than 99%, preferably more than 99.5% by mass of silicon carbide, and the matrix of said CMC is chosen from a matrix comprising more than 90%, preferably more than 95%, preferably more than 97%, preferably more than 98%, preferably more than 99% by mass of SiC+Si₃N₄+SiAlON. In one embodiment, in particular when the matrix comprises more than 50%, preferably more than 60%, preferably more than 70%, preferably more than 80% by mass of SiC, the complement to SiC+Si₃N₄+SiAlON in said matrix comprises metallic silicon, preferably said complement consists of more than 70%, preferably for more than 80%, preferably for more than 90% by mass, of metallic silicon.

In one embodiment, the CMC is such that the fibers of said CMC, optionally assembled in the form of single and/or assembled bundles, comprise more than 95%, preferably more than 97%, preferably more than 98%, preferably more than 99%, preferably more than 99.5% by mass of carbon, and the matrix of said CMC is chosen from a matrix comprising more than 90%, preferably more than 95%, preferably more than 97%, preferably more than 98%, preferably more than 99% by mass of SiC+Si₃N₄+SiAlON. In one embodiment, in particular when the matrix comprises more than 50%, preferably more than 60%, preferably more than 70%, preferably more than 80% by mass of SiC, the complement to SiC+Si₃N₄+SiAlON in said matrix comprises metallic silicon, preferably said complement consists of more than 70%, preferably for more than 80%, preferably for more than 90% by mass, of metallic silicon.

In one embodiment, the CMC is such that the fibers of said CMC, optionally assembled in the form of single and/or assembled bundles, comprise more than 95%, preferably more than 97%, preferably more than 98%, preferably more than 99%, preferably more than 99.5% by mass of oxides and have a chemical analysis such that SiO₂>70%, preferably SiO₂>80%, preferably SiO₂>90%, or even SiO₂>99%, by mass percentage relative to all oxides, and the matrix of said CMC is chosen from a matrix comprising more than 90%, preferably more than 95%, preferably more than 97%, preferably more than 98%, preferably more than 99% by mass of SiC+Si₃N₄+SiAlON. In one embodiment, in particular when the matrix comprises more than 50%, preferably more than 60%, preferably more than 70%, preferably more than 80% by mass of SiC, the complement to SiC+Si₃N₄+SiAlON in said matrix comprises metallic silicon, preferably said complement consists of more than 70%, preferably for more than 80%, preferably for more than 90% by mass, of metallic silicon.

Preferably, and regardless of the embodiment described above, the CMC comprises one or more following optional characteristics:
the CMC is sintered. In one embodiment, the sintering can be carried out during the first use (in other words in-situ);
the CMC has an open porosity, measured by imbibition, according to the principle of buoyancy, greater than 15%, preferably greater than 20%, preferably greater than 25%, preferably greater than 30% and preferably less than 45%, preferably less than 40%;
the CMC comprises more than 30%, preferably more than 40%, preferably more than 50%, preferably more than 60% and/or less than 70% by volume of fibers, optionally assembled in the form of single and/or assembled threads;
the fibers are grouped in the form of bundles, a bundle typically comprising several hundred to several thousand fibers;
the fibers, preferably the bundles, have a length greater than 50 mm, or even greater than 100 mm;
In a preferred embodiment, the fibers, preferably the bundles are arranged in the form of a fabric (having weft bundles and warp bundles) of a (nonwoven) web, a knit (single mesh or reinforced with unidirectional fibers and/or bundles), a braid or in the form of an object whose fibers and/or bundles are affixed against one another (filament winding or ESF (“Engineered Specialty Fabrics”).

All manufacturing methods making it possible to obtain a CMC can be implemented.

The manufacturing method may in particular comprise the following steps:
impregnating a set of fabrics or webs, preferably fabrics or webs of bundles, using a slip capable of forming a matrix after drying and/or sintering;
stacking said fabrics and/or webs, said stacking being able to be carried out by pressing, or under vacuum.

The fabrics or the layers can be stacked so that the bundles of the different fabrics or layers are all substantially in the same direction, or different directions, for example 45°, depending in particular on the desired mechanical properties.

### Coating

The coating comprises at least one layer comprising a crystalline oxide comprising at least the elements Li and Al. Said oxide may also optionally and preferentially comprise Si.

Preferably, said crystalline oxide has a melting temperature greater than the maximum temperature reached during the manufacture of the lithiated powder, in particular of the lithiated transition metal oxide powder.

Preferably, said crystalline oxide is chosen from LiAlO₂, LiAlSi₂O₆, Li₃AlSiO₅, LiAlSi₄O₁₀, LiAlSiO₄ and mixtures thereof, preferably from LiAlO₂, Li₃AlSiO₅, LiAlSi₂O₆ and mixtures thereof. More preferably, said crystalline oxide is chosen from Li₃AlSiO₅, LiAlSi₂O₆ and mixtures thereof.

The inventors demonstrated that the desired resistance to degradation can be obtained for small amounts of said crystalline oxide in the coating, in particular in a range from 15% to 25% by weight, in particular in the use case of a precursor of said crystalline oxide not comprising Al (Al coming in this case from the CMC).

Preferably, the coating comprises at least two layers, at least one of said layers comprising a crystalline oxide comprising at least the elements Li and Al, for example a layer comprising Li₄SiO₄, preferably consisting essentially of Li₄SiO₄, and a layer comprising a crystalline oxide comprising at least the elements Li, Si and Al, preferably the crystallized compound Li₃AlSiO₅.

For example, said layer comprising the compound comprising at least the elements Li, Si and Al (preferably a crystallized compound Li₃AlSiO₅) is located between said layer comprising a crystalline oxide comprising at least the elements Li and Al (preferably a layer of Li₄SiO₄) and the CMC.

According to one embodiment, the coating consists of more than 15%, preferably for more than 20%, preferably for more than 25%, by mass of one or more crystalline oxides comprising at least the elements Li and Al and optionally Si.

According to one embodiment, the coating is constituted for more than 30%, preferably for more than 40%, preferably for more than 50%, preferably for more than 60%, preferably for more than 70%, preferably for more than 80%, more preferably for more than 90%, preferably for more than 95%, or even preferably for more than 98%, by mass of one or more crystalline oxides comprising at least the elements Li and Al and optionally Si. More preferably, the coating consists essentially of one or more crystalline oxides comprising at least the elements Li and Al and optionally Si.

In one embodiment, the coating contains a precursor of at least one crystalline oxide comprising at least the elements Li and Al and optionally Si. In said embodiment, said at least one crystalline oxide comprising at least the elements Li and Al and optionally Si will subsequently be formed by raising the temperature, for example during the first use

In one embodiment, at least part of the Al and/or at least part of Si of the crystalline oxide comprising at least the elements Li and Al and optionally Si comes from the CMC, in particular by reacting with Li by raising the temperature, for example during the first use.

Preferably, the coating has the following chemical composition, by mass percentage relative to all oxides:
Li₂O: >0.5%, preferably >1%, preferably >2%, preferably >3%, and preferably <30%, preferably <25%, and/or
Al₂O₃: >2%, preferably >4%, preferably >6%, preferably >8%, preferably >10%, preferably >12%, and preferably <80%, and/or
SiO₂: in one embodiment <5%. In one embodiment, >10%, preferably >15%, preferably >20%, preferably >25%, preferably >30%, and preferably <80%, preferably <75%, preferably <70%, and
SiO₂+Al₂O₃+Li₂O>50%, preferably >60%, preferably >70%, or >80%, or >90%.

Preferably, the coating consists, for more than 90%, preferably for more than 95%, preferably for more than 98%, preferably for more than 99%, preferably for more than 99.5%, by mass of oxides. Preferably, the coating consists essentially of oxides.

The thickness of said coating is preferably greater than 50 μm, preferably greater than 100 μm (microns), preferably greater than 200 μm, preferably greater than 300 μm, or even greater than 400 μm, or even greater than 500 μm, or even greater than 600 μm and/or preferably less than 2000 μm, preferably less than 1500 μm, preferably less than 1000 μm, preferably less than 800 μm.

Preferably, the surface of the coated inner walls comprises the bottom of the container and the part of the sides in contact with said bottom. In other words, the coating extends over the lower part of the sides of the container, the container being considered in its operating position, said part being the one in contact with the powders during the use of said container.

Preferably, more than 85%, preferably more than 90%, preferably more than 95%, preferably more than 96%, preferably more than 98%, preferably more than 99% of the surface of the interior walls of the container are coated with said coating. Preferably, the coating extends over substantially the entire surface of the interior walls of the container.

Preferably, at least some, preferably the entire surface of the outer wall of the bottom of the container is coated with the coating.

In one embodiment, more than 90%, preferably more than 95%, preferably more than 99% of the total surface area of the walls of the container is coated with the coating.

Preferably, the coating has undergone a heat treatment before its use, the maximum temperature reached during said heat treatment preferably being greater than 900° C., preferably greater than 950° C. and less than the degradation temperature of the CMC.

In the case of a CMC comprising fibers, optionally assembled in the form of bundles, having a chemical analysis such that SiO₂>80% by mass, the maximum temperature reached during said heat treatment is preferably less than 1000° C.

In the case of a CMC comprising fibers, optionally assembled in the form of bundles, having a chemical analysis such that Al₂O₃>65% or comprising fibers, optionally assembled in the form of bundles, comprising more than 95% silicon carbide, the maximum temperature reached during said heat treatment is preferably less than 1300° C.

Preferably, the holding time at said maximum temperature is greater than 5 hour, preferably greater than 8 hours and less than 20 hours, preferably less than 15 hours.

The implementation of a heat treatment advantageously makes it possible to considerably improve the adhesion of the coating.

Said heat treatment can also make it possible to obtain at least one crystalline oxide comprising at least the elements Li and Al present in the coating, in particular from a precursor of said oxide and/or when at least part of Al comes from CMC.

The coating can be applied to at least part of the surface of the interior walls of the container according to any technique known to the person skilled in the art, in particular by application using a brush, by spraying, in particular a wet spray, by vacuum impregnation.

In one variant, precursors of said oxide are applied to at least part of the surfaces of the walls of the container and then transformed into said oxide, for example using a heat treatment.

Preferably, the precursors of said oxide are chosen from:
lithiated bayerite,
Li₄SiO₄, Al coming in this case of the CMC (the crystalline oxide comprising at least the elements Li and Al which can then be Li₃AlSiO₅),
and mixtures thereof.

### Container

The container may have any shape.

The perimeter of said container according to the invention can be chosen from a polygon, in particular a rectangle and a square, a circle or an ellipse.

Preferably, the container according to the invention comprises a bottom and at least one side, the bottom and the at least one side preferably having an average thickness of less than 20 mm, more preferably less than 15 mm, or even less than 10 mm, and/or preferably greater than 2 mm, preferably greater than 4 mm, more preferably greater than 5 mm.

In one embodiment, the bottom of said container has a thickness greater than that of its side, preferably 10% greater, preferably 20% greater, preferably 30% greater.

In one embodiment, the bottom and the side of said container have a difference in thickness less than 10%, preferably less than 5%. Preferably, in said embodiment, the bottom of said container has a thickness substantially identical to that of its side.

In one embodiment, the thickness of the walls is not constant. Preferably, the thickness of the sides is greater on the side of the container bottom. Preferably, the part of the sides in contact with the container bottom has a thickness greater than 10% at the thickness of the part of the sides located opposite the container bottom.

In one embodiment, the container according to the invention has a length, that is, a greater length less than 500 mm, preferably less than 400 mm, or/or preferably greater than 100 mm, preferably greater than 200 mm, and a width, that is the smallest dimension measured perpendicular to the length of less than 500 mm, preferably less than 400 mm, or/or preferably greater than 100 mm, preferably greater than 200 mm.

In one embodiment, the container can be compartmentalized into at least two parts, said at least two parts being able to be separated by a space allowing the circulation of the gases during the heat treatment aimed at synthesizing the powders comprising lithium oxide, in particular an oxide of a metal or several lithiated transition metals.

In one embodiment, the angle between the bottom of the container and said at least one side is equal to 90°. In one embodiment, said angle is greater than 90° and less than 100°.

In one embodiment, the container according to the invention has a diameter of less than 500 mm, preferably less than 400 mm, or/or preferably greater than 100 mm, preferably greater than 200 mm.

Preferably, the container according to the invention has a volume greater than 0.1 liter, preferably greater than 1 liter, preferably greater than 2 liters, preferably greater than 3 liters and/or preferably less than 25 liters, preferably less than 20 liters, preferably less than 15 liters.

In one embodiment, the CMC bottom and sides of the container according to the invention form a monolithic assembly. In other words, said bottom and sides are one and the same part, the connection between the bottom and the sides comprising a radius, preferably greater than 5 mm, preferably greater than 10 mm, preferably greater than 20 mm.

In one embodiment, the container is an assembly of different parts made of CMC, for example plates made of a CMC, the connection between said various parts being able in particular to be made by means of a mortise and tenon joint, and/or bracketed assembly, and/or nesting assembly (in particular using notches or grooves), and/or metal or ceramic pins, and/or metal or ceramic screws and/or metal or ceramic rivets, and/or metal or ceramic keys.

### Examples

The following non-limiting examples are given with the aim of showing the invention.

The resistance to degradation during the synthesis of the oxide powders of a metal or of several lithiated transition metals is evaluated by the following method:
2 g of lithium hydroxide are placed at the center of the surface of each tile, having a coating or not, depending on the examples. The assembly is then placed in an electric furnace and undergoes the following heat treatment, in air:
   rise to 900° C.,
   hold at 900° C. for 10 hours,
   drop to ambient temperature.

For each example, before the degradation resistance test, a tile, coated or not depending on the examples, is cut so as to obtain an edge face of the central zone of said tile, and said edge face is coated with a resin and mirror-polished. Then, said polished edge is observed using an optical microscope, in order to measure the average thickness E₀ of the tile in the example, before the degradation resistance test, said average thickness E₀ being the arithmetic mean of the thicknesses measured over 5 different observed zones.

For each example, after the degradation resistance test, a tile, coated or not depending on the examples, is cut so as to obtain an edge face of the central zone of said tile, and said edge face is coated with a resin and mirror-polished. Then, said polished edge is observed using an optical microscope, in order to measure the average thickness E₁ corresponding to the thickness of visually unmodified material in the tile of the example, said average thickness E₁ being the arithmetic mean of the thicknesses measured over 5 different observed zones.

The degradation resistance of the example is defined by E₀-E₁. The lower the difference E₀-E₁, the higher the degradation resistance.

The manufacturing protocol of the examples is described below:

### a) Tile Used in Example 1 Outside the Invention

The tile used in example 1 outside the invention is a plate of the Alundum® AH199, material, sold by Saint-Gobain Performance Ceramics and Refractories, having the following dimensions: 50×50×11 mm³.

### b) Tiles Used in Example 2 Outside the Invention and in Example 3 According to the Invention

The tiles used in said examples are HT-C Typ SM sintered CMC tiles, sold by the company Inovaceram with dimensions of 50×50×4.5 mm³

c) Suspension for Obtaining the Coating of the Coated Tiles from Examples 1 and 3

Lithium hydroxide is introduced into water at a concentration equal to 0.3 mol/L, then the assembly is kept stirring until the lithium hydroxide is dissolved. Then, Ludox AS40 colloidal silica, sold by Sigma Aldrich is added under stirring in such a way that the molar ratio of lithium hydroxide to SiO₂ is equal to 4.

The pH is then adjusted to a value equal to 8.5 using citric acid. Stirring is maintained for 10 minutes after introduction of the citric acid. The suspension obtained is then placed in a drying oven at 65° C. for 18 hours.

### d) Manufacturing the Coating on the Surface of the Coated Tiles

A coating is obtained on the Alundum® AH199 tile and on the sintered CMC tile using the following method.

To carry out example 1, the suspension obtained at the end of paragraph c) is applied to the tile described in paragraph a) using a brush.

To carry out example 3, the suspension obtained in paragraph c) is applied to one of the tiles described in paragraph b) using a brush.

Then after drying for 12 hours at 60° C., the dried coated tiles undergo the following heat treatment HT in an electric furnace:
rise from 20° C. to 900° C., at a rate equal to 10° C./min,
hold at 900° C. for 10 hours,
natural drop to room temperature.

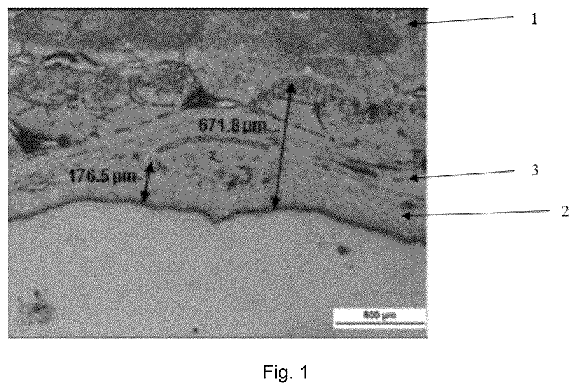

The attached FIG. 1 is an image obtained under an optical microscope during the observation of the thickness after sawing the coated tile of example 3 before the degradation resistance test was carried out. Two layers present on the surface of the CMC tile (1) can be distinguished: a layer (2) of Li₄SiO₄ and a layer (3) comprising the crystallized compound Li₃AlSiO₅.

The tiles thus obtained then undergo the degradation resistance test described above.

Table 1 below summarizes the result of the degradation resistance test, the examples being representative of a container used for the synthesis of an oxide powder of a metal or of several lithiated transition metals.

TABLE 1

| | | Crystalline oxide comprising at | |
|---|---|---|---|
| | | least the elements Li and Al in | |
| | Average | the coating highlighted by X-ray | |
| | thickness | diffraction carried out on a | |
| | before | polished surface of an edge face | Degradation |
| | test E₀ | from the example before the | resistance, |
| Examples | (mm) | degradation resistance test. | E₀-E₁ (mm) |
| 1(*) | — | — | — |
| Coated tile made of | | | |
| Alundum ® AH199 | | | |
| 2(*) | 4.5 | — | 4.5 |
| Uncoated CMC tile | | | |
| 3 | 4.5 | Li₃AlSiO₅ | 1 |
| Coated CMC tile | | | |

(*)outside the invention

The presence of the crystalline oxide Li₃AlSiO₅ in the coating of example 3 is demonstrated by X-ray diffraction carried out on a polished surface of an edge face from this example before the degradation resistance test.

After the heat treatment HT, example 1, outside the invention, has a scaled coating, which does not adhere to the Alundum® AH199 support plate. It was therefore not possible to carry out the resistance test to degradation.

On the contrary, example 3 according to the invention has a homogeneous coating without surface cracks. A comparison of examples 1 outside the invention and example 3 according to the invention shows the need for a CMC as a support material for the coating.

A comparison of examples 2 outside the invention, and 3 according to the invention, shows that the resistance to degradation of example 3 is equal to 1 mm, much less than that of example 2 equal to 4.5 mm.

The above examples show the advantages of the present invention, and in particular of the particular choice of a combination of a ceramic matrix composite and of its coating comprising a crystalline oxide comprising at least the elements Li and Al or a precursor of said crystalline oxide.

Low resistance to degradation was also measured when a suspension of lithiated bayerite is alternatively used to make the coating on the tiles surface in a CMC.

These results show the effectiveness of a container according to the invention.

Of course, the present invention is not limited to the embodiments described, which are provided merely for showing purposes.

In particular, the products according to the invention are not limited to particular shapes or dimensions.

1. A container made of a ceramic matrix composite, wherein a surface of interior walls of said container are covered at least partially with a coating comprising at least one layer comprising a crystalline oxide comprising at least the elements Li and Al or a precursor of said crystalline oxide.

2. The container according to claim 1, wherein the crystalline oxide further comprises the element Si.

3. The container according to claim 1, said crystalline oxide being chosen from LiAlO₂, LiAlSi₂O₆, Li₃AlSiO₅, LiAlSi₄O₁₀, LiAlSiO₄ and mixtures thereof.

4. The container according to claim 1, wherein ceramic fibers of the ceramic matrix composite, optionally assembled in the form of single and/or assembled bundles, are selected from fibers comprising more than 95% by mass of oxides, carbides, nitrides, carbon and mixtures thereof.

5. The container according to claim 4, wherein the ceramic fibers of the ceramic matrix composite, optionally assembled in the form of single and/or assembled bundles, are selected from fibers:
comprising more than 95% by mass of oxides and having a chemical analysis such that SiO₂>70% by mass percentage relative to all oxides, or
comprising more than 95% by mass of oxides and exhibiting a chemical analysis such that 45%<SiO₂<80%, and iron oxide, expressed in the form Fe₂O₃ in an amount such that 1%<Fe₂O₃<20% and 5%<Al₂O₃<25%, as a mass percentage relative to all oxides, or
comprising more than 95% by mass of oxides and having a chemical analysis such that Al₂O₃>65% by mass percentage relative to all oxides, or
comprising more than 95% by mass of silicon carbide, or
comprising more than 95% by mass of carbon,
and mixtures thereof.

6. The container according to claim 5, wherein the ceramic fibers of the ceramic matrix composite, optionally assembled in the form of single and/or assembled bundles, are selected from the fibers more than 95% composed of alumina by mass, the fibers more than 95% composed of silica by mass, the fibers more than 95% composed of mullite by mass, the fibers more than 95% composed of mullite and corundum by mass, the fibers more than 90% composed by mass of basalt, the fibers more than 95% composed of glass by mass, the fibers more than 95% composed of silicon carbide by mass, the fibers more than 95% composed of carbon and mixtures thereof by mass.

7. The container according to claim 1, wherein the matrix of the ceramic matrix composite is chosen from a matrix comprising more than 95% by mass of oxides, carbides, nitrides, sialons and mixtures thereof.

8. The container according to claim 7, wherein the matrix of the ceramic matrix composite is selected from a matrix
comprising more than 95% by mass of oxides and having a chemical analysis such that SiO₂+Al₂O₃+ZrO₂+HfO₂+MgO>70% by mass percentage relative to all oxides, or
comprising more than 95% by mass of oxides and having a chemical analysis such that SiO₂+Al₂O₃>70% by mass percentage relative to all oxides, or
comprising more than 95% by mass of oxides and having a chemical analysis such that Al₂O₃+ZrO₂+HfO₂>70% by mass percentage relative to all oxides, or
comprising more than 95% by mass of oxides and having a chemical analysis such that SiO₂+Al₂O₃+MgO>70% by mass percentage relative to all oxides, or
comprising more than 90% by mass of SiC+Si₃N₄+SiAlON.

9. The container according to claim 1, wherein the coating:
comprises at least one layer comprising a crystalline oxide comprising at least the elements Li, Al and Si, and/or
consists of more than 15% by mass of one or more crystalline oxides comprising at least the elements Li and Al, and/or
contains a precursor of at least one crystalline oxide comprising at least the elements Li and Al, and/or
has the following chemical composition, by mass percentage relative to all oxides:
SiO₂+Al₂O₃+Li₂O>50%, and
Li₂O: >0.5% and <30%, and/or
Al₂O₃: >2% and <80%, and/or
SiO₂: <5%, or 10%<SiO₂<80%, and/or
consists of more than 90% by mass of oxides, and/or
has a thickness greater than 50 μm and/or less than 2000 μm.

10. The container according to claim 9, wherein the precursor of the crystalline oxide comprising at least the elements Li and Al is chosen from:
Lithiated bayerite,
Li₄SiO₄,
and mixtures thereof.

11. The container according to claim 1, wherein more than 99% of the surface of the interior walls is coated by said coating.

12. The container according to claim 1, comprising a bottom and at least one side.

13. A method comprising providing a container according to claim 1, for manufacturing an oxide powder comprising lithium.

14. The container according to claim 1, wherein more than 80% of the surface of the interior walls of said container are covered with the coating.

15. The method according to claim 13, wherein the oxide powder is an oxide of a metal or several lithiated transition metals.
